(19) United States
(12) Patent Application Publication
(10) Pub. No.: US 2003/0007239 A1
(43) Pub. Date: Jan. 9, 2003

(54) Colored rotating granular body and production method therefor, and display device thereof

(75) Inventors: Katsura Sakamoto, Kawasaki (JP); Mitsuo Ozaki, Kawasaki (JP); Norio Sawatari, Kawasaki (JP); Satoshi Takezawa, Kawasaki (JP); Atsunori Minagawa, Kawasaki (JP)

Correspondence Address: Patrick G. Burns, Esq., GREER, BURNS & CRAIN, LTD., Suite 2500, 300 South Wacker Dr., Chicago, IL, 60606, US

(73) Assignee: FUJITSU LIMITED

(21) Appl. No.: 10/187,873

(22) Filed: Jul. 2, 2002

(30) Foreign Application Priority Data
Jul. 3, 2001 (JP) 2001-202731
Jan. 16, 2002 (JP) 2002-007558

(51) Int. Cl. G09G 3/38; B29B 9/00

(52) U.S. Cl. 359/296; 264/5; 264/8; 264/10; 264/15; 345/107

(57) ABSTRACT

A colored rotating granular body 21 has a surface color-coded in two different colors and electrification characteristics for each color and rotates by an effect of an electric field to display an associated color face. For producing the colored rotating granular bodies 21, a suspension 11 of granular bodies 1 each already in a colored state and functioning as a base and an emulsion 12 of a monomer 2 sill in an uncolored state are mixed, the monomer 2 is unevenly attached to a part of a surface of each of the granular bodies 1, the monomer attached to the granular bodies 1 are polymerized to obtain granular bodies 3 composed of the polymerized monomer, thereafter only the granular bodies 3 are selectively colored, and snowman-shaped complexed resin granular bodies 4 composed of the granular bodies 1 and the granular bodies 3 are integrally spheroidized. The above configuration realizes colored rotating granular bodies each having a good balance between colored portions, a diameter too small to be obtained by a mechanical granular body production method and an excellent sphericity, and being easily mass-produced.

### CROSS-REFERENCE TO RELATED APPLICATIONS

This application is based upon and claims priority of Japanese Patent Application Nos. 2001-202731, filed on Jul. 3, 2001, and 2002-007558, filed on Jan. 16, 2002, the contents being incorporated herein by reference.

### BACKGROUND OF THE INVENTION

1. Field of the Invention

The present invention relates to a colored rotating granular body having a surface color-coded in two different colors and rotating by the effect of an electric field to display an associated color face and a production method therefor, and a display device thereof.

2. Description of the Related Art

Recently, with developments in portable digital assistants, value-added networks and the like, development of display devices having a thin-profile, light weight and good portability have received increased attention. In particular, expectations are increasing for a display device which performs an image display by changing optical absorption characteristics and optical reflection characteristics by an electric field and has the ability to easily rewrite electronic information, in addition to flexibility equal to paper, that is, a display device commonly referred to as so-called digital paper, electronic paper, or paper-like display.

The display element which changes in optical absorption characteristics and optical reflection characteristics by the application of an electric filed includes a micro capsule containing rotating granular bodies each made by joining hemispheres having different colors and electric characteristics with a dielectric fluid, a micro capsule containing a solvent made by dispersing electrophoretic granular bodies therein and being colored as disclosed in Japanese Patent Application No. 62-244679, or a liquid crystal/polymer composite film containing a dichroic pigment and a smectic liquid crystal.

These display elements have characteristics such as memorizing ability capable of holding image information with no power supply and reflective display. Since the display elements can be formed on PET films provided with electrodes and the like, they are sheet-type display devices which are thin and light-weight and can be folded. Accordingly, these display elements are expected as alternatives to paper.

In particular, a display medium disclosed in each of U.S. Pat. Nos. 4,126,854 and 4,143,103, using two-color rotating granular bodies each having hemispheres separated to have different colors and electrification characteristics, is well known as a display exhibiting superior contrast characteristics as compared to other methods. This display medium has a configuration having a base material that is a layer having a plurality of cavities filled with a dielectric fluid and being optically transparent, and rotating granular bodies in the cavities. Further, the two-color rotating granular body is a colored rotating granular body which has two half areas having different colors and electrification characteristics in one granular body. Therefore, the application of an electric field causes electrophoretic migration and rotational movement of the granular body for performance of an image display.

Suggested as methods and materials for producing the two-color rotating granular bodies are as follows:

(1) A method, disclosed in U.S. Pat. No. 5,262,098, of melting two kinds of wax granular bodies having different colors to join, spheroidizing them by surface tension, and thereafter solidifying them, using carnauba wax, titanium oxide, and carbon black as materials.

(2) A method, disclosed in Japanese Patent Applications No. 9-246738 and No. 9-246739, of evaporating or applying metal, carbon black, antimony sulfide, or the like on the surfaces of light transmitting granular bodies, using glass or resin as a material.

(3) A method, disclosed in Japanese Patent Applications No. 9-24857 and No. 9-330135, of subjecting granular bodies made of a photosensitive material to exposure, development, and fixation for coloring, using zinc oxide (coupler: toner) and hydrophilic polymer (coupler: silver halide) as materials.

Further, as a method for producing rotating granular bodies using a polymerization method, a method is suggested for producing two-color rotating granular bodies by dispersing granular bodies made by adding carbon black to polyethylene wax, in an emulsion made by mixing titanium oxide and styrene monomers, and polymerizing them.

The two-color rotating granular bodies produced by these techniques are normally dispersed in a medium such as silicon rubber and rotated by the application of an electric field to change display. Therefore, it is necessary to evenly disperse the two-color rotating granular bodies whose diameters are controlled because the dispersion state of the two-color rotating granular bodies greatly influences the resolution and brightness of a display device. However, in the aforesaid U.S. Pat. No. 5,262,098 and so on, for example, the two-color rotating granular bodies are produced by flowing two color low-molecular weight resins, that is, the so-called wax solutions, onto and under a spinning disc, spinning minute droplets in which the two color wax solutions joined each other off from the disc end portion by centrifugal force caused by the spin of the disc, and spheroidizing them in fluid by surface tension. Accordingly, the diameters of the granular bodies greatly depend on the spin speed of the disc, the temperatures and viscosities of the wax solutions, the air resistance when spun off, and so on. For this reason, it is extremely difficult to produce colored rotating granular bodies having a uniform diameter and each made by joining two color wax hemispheres with sufficient color concentrations.

Further, it is also difficult to color only equal halves respectively in a method for producing colored rotating granular bodies such as a method of color-coding by dip coating a hemisphere part of a previously prepared monochromatic rotating granular body or by evaporating pigment onto the part, or a method of coloring only a hemisphere by previously mixing a photosensitive material in a resin and performing processing such as exposure and development.

Further, as a method for producing colored rotating granular bodies more easily, there is a method of die-cutting a resin film directly in a size of a granular body diameter to obtain resin granular bodies, and spheroidizing them in an appropriate fluid by surface tension. However, it is difficult to produce rotating granular bodies which have the same granular body diameter and each of which is colored in two colors, one for each hemisphere respectively because unevenness in thickness and hardness of the resin film causes cracks and fins at the edge portions of the granular bodies.

Furthermore, the above-described production methods have difficulties in mass production of colored rotating granular bodies especially because they are mechanical methods, and thus still have a problem in efficiency of productivity.

Moreover, the production method using the polymerization method which relatively easily mass-produces spherical granular bodies still has a difficult problem of increasing the contrast (specifically, providing a difference in reflectance between a white part and a black part of 50% or more) by coloring.

### SUMMARY OF THE INVENTION

The present invention solves and overcomes the above-described problems, and it is an object of the invention to provide a method for producing colored rotating granular bodies each having a high contrast between colors, a diameter too small to be obtained by a mechanical granular body production method and an excellent sphericity and being easily mass-produced in a short time, and to provide the colored rotating granular body.

Further, it is another object of the present invention to provide a display device including the colored rotating granular bodies having the above-described configuration as display elements and having a high resolution for extremely fine image.

After an earnest study, the present inventor reaches aspects of the invention shown below.

A first aspect of a method for producing colored rotating granular bodies according to the present invention comprises: a first step of mixing a suspension of first granular bodies each already in a colored state and functioning as a base and a monomer mixture which becomes second granular bodies, and unevenly attaching the monomer mixture to a part of a surface of each first granular body for complexation; a second step of polymerizing the monomer mixture attached to the first granular bodies to obtain the second granular bodies; and a third step of selectively coloring only the second granular bodies.

A second aspect of a method for producing colored rotating granular bodies according to the present invention comprises: a first step of mixing a suspension of first granular bodies each already in a colored state and functioning as a base and a monomer mixture which becomes second granular bodies, and unevenly attaching the monomer mixture to a part of a surface of each first granular body for complexation; a second step of selectively coloring only a part of the monomer mixture which becomes the second granular bodies; and a third step of polymerizing the monomer mixture attached to the first granular bodies to obtain the second granular bodies.

Each of the first and second aspects further comprises, as necessary, a fourth step of integrally spheroidizing the complexed first granular bodies and second granular bodies.

In this case, it is preferable that the first granular body is white, and that the first granular body is composed of one or a mixture of two or more kinds selected from the group consisting of polyethylene, polypropylene, polyester, polyacryl, polyalkyd, polyimide, polycarbonate, carnauba wax, and paraffin wax, and is colored at least with a white pigment.

Further, it is preferable that the white pigment is one or a mixture of two or more kinds selected from the group consisting of titanium oxide, zinc oxide, silicon oxide, alumina, and calcium carbonate.

Furthermore, it is preferable that the monomer is one or a mixture of two or more kinds selected from the group consisting of styrene derivatives, acrylic esters, acrylic acid derivatives, methacrylic esters, methacrylic acid derivatives, olefin derivatives, vinyl ether derivatives, and vinylester derivatives.

Moreover, it is preferable that the first step comprises the steps of: obtaining an emulsion of the monomer; and mixing the suspension of the first granular bodies and the emulsion of the monomer.

Further, it is preferable that the step (the third step in the first aspect and the second step in the second aspect) is a step of performing the coloring of the second granular bodies using a dye.

It is desirable that the dye has a dissolving ability of a solubility of less than 1 wt % to a substance obtained by melting a component of the first granular body or a monomer constituting the first granular body, and has a solubility of 2 wt % or more to a monomer constituting the second granular body.

Further, it is preferable that the fourth step, which is performed when necessary, is a step of performing the spheroidization by heating at softening temperatures or glass transition temperatures or more of the first granular body and the second granular body.

Further, a colored rotating granular body according to the present invention is a display element having a surface color-coded in two different colors and different electrification characteristics for each color and rotating by an effect of an electric field to display an associated color face, the granular body comprising: a first granular body made of a predetermined resin; and a second granular body obtained by coloring a predetermined monomer and polymerizing it while attached to the first granular body, the first granular body and the second granular body being integrally spheroidized.

Further, a display device according to the present invention is a display device formed with a pair of opposing electrode substrates at least one of which is transparent and a layer in which colored rotating granular bodies are dispersed and held between the opposing electrode substrates such that the colored rotating granular bodies are capable of rotational movement therebetween.

### BRIEF DESCRIPTION OF THE DRAWINGS

FIG. 1 is a diagram showing a method for producing colored rotating granular bodies in a first embodiment of the present invention in order of step;

FIG. 2 is a diagram schematically showing a structure of the colored rotating granular body in the first embodiment of the present invention;

FIG. 3 is a diagram showing a method for producing colored rotating granular bodies in a second embodiment of the present invention in order of step;

FIG. 4 is a characteristic diagram showing the relationship between the solubility of a dye to a monomer and the reflectance of a colored resin granular body; and

FIG. 5 is a schematic cross-sectional view showing a display device in a third embodiment of the present invention.

### DETAILED DESCRIPTION OF THE PREFERRED EMBODIMENTS

Hereinafter, preferred embodiments to which the present invention is applied will be described in detail with reference to the drawings.

First Embodiment

Configuration of Colored Rotating Granular Body and Production Method Therefor

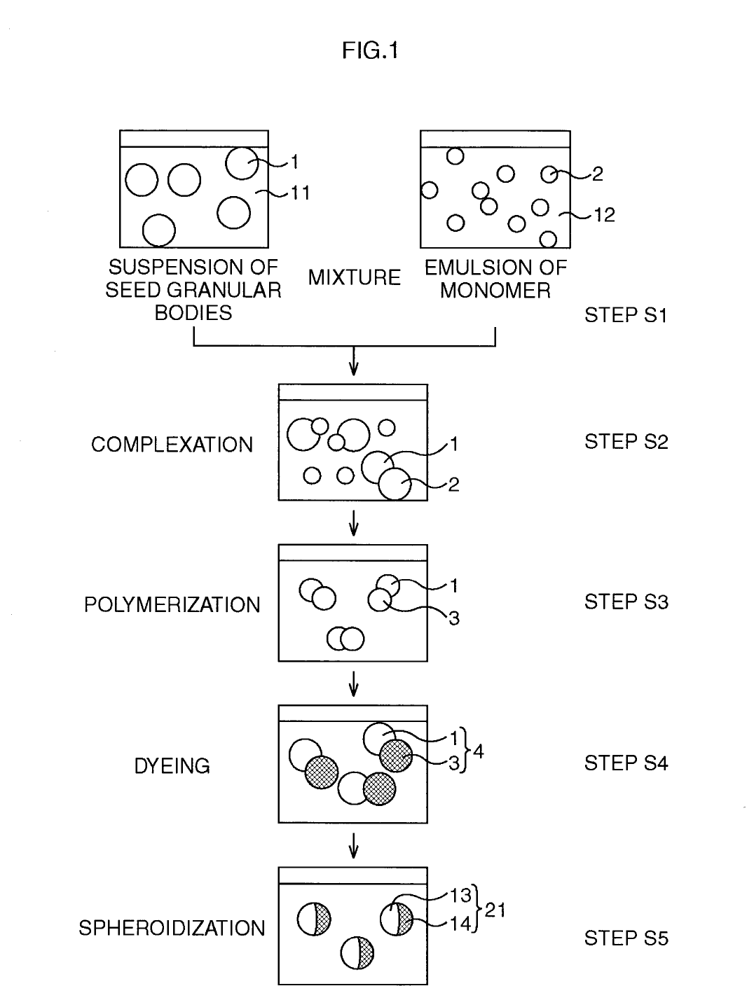

FIG. 1 is a diagram showing a method for producing colored rotating granular bodies in this embodiment in order of step. It should be noted that a configuration of the colored rotating granular body is explained together with the production method for convenience in this embodiment.

First of all, as shown in step S1, a suspension 11 of seed granular bodies 1 which are first granular bodies to become white parts and an emulsion 12 of a monomer 2 are prepared.

Suggested to be used as the seed granular bodies which become the white parts of the colored rotating granular bodies is one or a mixture of two or more kinds selected from the group consisting of polyethylene, polypropylene, polyester, polyacryl, polyalkyd, polyimide, polycarbonate, carnauba wax, amide wax, and paraffin wax. In particular, polypropylene and polyethylene each having a high degree of whiteness and high crystallinity in a solid state are desirable.

Further, in order to enhance the degree of whiteness and electrification performance of the seed granular bodies, one or a mixture of two or more kinds of white inorganic pigments such as titanium oxide, zinc oxide, silicon oxide, alumina, calcium carbonate, and so on, is dispersed in a base resin.

A grinding method, a precipitation method, and the like can be cited as a method for producing granular bodies in which an inorganic pigment is dispersed.

The grinding method can produce granular bodies by mixing the aforesaid resin and white inorganic pigment, and melt-kneading them using a kneader, an extruder, or the like, thereafter roughly grinding the obtained melt-kneaded substance, then finely grinding it with a jet mill or the like, and finally using an air classifier.

The precipitation method is a method of dispersing a white inorganic pigment, which has been subjected to hydrophobic processing with a silane coupling agent or the like, in a molten resin in an oil bath, agitating it in a warm bath, and thereafter gradually decreasing its temperature so as to precipitate granular bodies.

The white granular bodies produced by the above-described method can be finely dispersed in water to obtain a suspension.

Next, the monomer emulsion 12 to be absorbed is explained.

Any monomer can be used here as long as it has one ethylene unsaturated bond in one molecule. For example, it is suggested to use styrene monomers such as styrene, o-methyl styrene, m-methyl styrene, p-methyl styrene, p-ethyl styrene, 2,4-dimethyl styrene, p-phenyl styrene, p-chloro styrene, 3,4-dichloro styrene, p-n-butyl styrene, p-tert-butyl styrene, p-n-hexyl styrene, p-n-octyl styrene, and p-n-dodecyl styrene; olefin monomers such as ethylene, polypropylene, butylene, isobutylene; vinylester monomers such as vinyl acetate, vinyl propionate, and vinyl butyrate; acrylic ester monomers such as methyl acrylate, ethyl acrylate, n-butyl acrylate, isobutyl acrylate, n-propyl acrylate, n-octyl acrylate, dodecyl acrylate, 2-ethylhexyl acrylate, stearyl acrylate, 2-chloro ethyl acrylate, and phenyl acrylate; methacrylic ester monomers such as methyl methacrylate, ethyl methacrylate, n-butyl methacrylate, isobutyl methacrylate, n-propyl methacrylate, n-octyl methacrylate, dodecyl methacrylate, 2-ethylhexyl methacrylate, stearyl methacrylate, 2-chloro ethyl methacrylate, and phenyl methacrylate; vinyl ether monomers such as vinyl methyl ether, vinyl ethyl ether, and vinyl isobuthyl ether; and vinyl monomers such as acrylic acid or methacrylic acid derivatives, that is, acrylonitrile, methacrylonitrile, acrylamide, and so on. These monomers may be used singly or in a combination of two or more kinds.

Further, in order to control molecular weight distribution of the resin by combining with these monomers, divinylbenzene, divinyl naphthalene, divinyl ether, or the like may be added as a crosslinking agent.

To these monomers, a polymerization initiator is added in advance.

Cited as the polymerization initiator are peroxide such as benzoyl peroxide and lauroyl peroxide; persulfate such as potassium peroxydisulfuric acid, sodium persulfate, potassium persulfate, and ammonium persulfate; azo compound such as 2,2-azobis (2,4-dimethylvaleronitrile), 2,2-azobis (isobutyronitrile), and so on. Normally, the amount of use of the polymerization initiator preferably ranges from 0.01 wt % to 10 wt % of the weight of the monomer, and more preferably, 0.05 wt % to 7 wt % thereof. Further, a polymerization modifier such as tert-dodecanethiol or the like may be added as necessary in addition to the polymerization initiator.

Further, an emulsifier may be added to water in advance to prepare the monomer emulsion.

Cited as the emulsifier are an anionic surface active agent such as sodium dodecyl sulfate; an nonionic surface active agent such as polyoxyethylene lauryl ether and polyoxyethylene nonyl phenyl; a cationic surface active agent such as lauryl trimethylammonium chloride, and so on.

Subsequently, as shown in step S2, the emulsion 12 of the monomer is added to the suspension 11 of the seed granular bodies 1, so that the monomer 2 attaches to the seed granular bodies 1 to complex with each other.

This complexation is carried out by leaving a liquid mixture at room temperature not higher than a temperature of polymerization of the monomer or under cooling conditions. A temperature in this event close to the temperature of polymerization of the monomer will increase a possibility that the monomer does not complex with the seed granular bodies but polymerizes while keeping the state of monomer granular bodies. If the monomer granular bodies polymerize as they are, they do not form into snowman-shaped granular bodies but into substantially spherical resin granular bodies. In order to obtain snowman-shaped granular bodies, the complexation is desirably conducted at a temperature as low as possible but not so low as the water-based solvent start freezing.

A period required for the complexation is normally from about several tens of minutes to about several hours. It is conceivable that when the suspension 11 of the seed granular bodies and the monomer emulsion 12 are mixed, a trace amount of molecules of the monomer 2 dissolved in water precipitate on the surfaces of the seed granular bodies 1. The monomer 2 transfers from the monomer emulsion 12 to the seed granular bodies 1 as described above. It is considered here that when the monomer 2 and the seed granular body 1 have a high affinity for each other, the seed granular body 1 absorbs the monomer 2 and swells to increase in granular body diameter. In this case, no snowman-shaped granular body will be obtained.

Meanwhile, it is conceivable that if a seed granular body which does not dissolve in a monomer is used, a trace amount of the monomer dissolved in water locally gathers when precipitating on the surface of the seed granular body to reduce its surface energy and thus unevenly attaches to the surface of the seed granular body. It is conceivable that the complexation of the monomer with the resin granular body advances to provide a snowman-shaped granular body.

In this embodiment, the monomer 2 is made into fine granular bodies and dispersed in the emulsion 12 before the monomer 2 and the seed granular bodies 1 are mixed.

This increases the total surface area of the monomer to accelerate elution of the monomer into water. Further, it is desirable that the diameter of the monomer granular body is made smaller than that of the seed granular body. If the diameter of the monomer granular body is large, a part of the monomer does not complex with the seed granular bodies but is prone to become by-product granular bodies. For emulsification of the monomer, it is possible to use a typical emulsifier, for example, a rotor-stator emulsifier, a high-pressure emulsifier, an ultrasonic emulsifier, or the like.

Subsequently, as shown in step S3, the monomer 2 attached to the seed granular bodies 1 those are the first granular bodies is polymerized by a method such as heating, light irradiation, or the like to obtain polymerized granular bodies 3 those are second granular bodies composed of the polymerized monomer 2. During the polymerization, it is desirable to perform slow agitation so as to prevent the granular bodies from settling. As a result, snowman-shaped resin granular bodies 4 can be obtained each of which is composed of the seed granular body 1 and the second polymerized granular body 3.

It should be noted that a water-soluble polymerization inhibitor such as hydroquinone or the like may be added before the polymerization in order to prevent occurrence of by-product granular bodies in water.

Further, a suspension stabilizer may be added before the polymerization in order to enhance the stability of the snowman-shaped resin granular bodies 4 obtained by complexing the seed granular bodies 1 and second polymerized granular bodies 3. As the suspension stabilizer, it is possible to use a hydrophilic polymer such as polyvinyl alcohol, polyvinyl pyrrolidone, gelatin, or methylcellulose; a water-insoluble powder such as tricalcium phosphate, barium sulfate, aluminum hydroxide, or silica; an anionic or a nonionic surface active agent, or the like.

Subsequently, as shown in step S4, only the polymerized granular bodies 3 those are the polymerized parts of the monomer are selectively colored by dyeing. As a result, the white part is constituted by the seed granular body 1 and the colored part is constituted by the polymerized granular body 3 in the snowman-shaped resin granular body 4. It should be noted that, for production of a colored rotating granular body, while the technique of using a dye or a pigment for coloring a granular body is disclosed, but the description is limited only to the outline thereof, a series of specific disclosure is not made which includes polymerization and the like (specific description on complexation, polymerization, dyeing, spheroidization, and the like) as in the present invention.

It is desirable to use a disperse dye for dyeing only the polymerized granular bodies 3 in water. Specifically, it is possible to use C. I. Disperse Yellow 1, 3, 7 and 8, C. I. Disperse Orange 3, 20 and 21, C. I. Disperse Red 43, 54, 56, 65, 72, 73, 82, 84, 88, 99 and 152, C. I. Disperse Violet 10 and 24, C. I. Disperse Blue 43, 44, 85, 88, 94 and 96, and the like.

These disperse dyes have characteristics of not dyeing the resin in the base granular body such as polyethylene, polypropylene, polyolefin, or the like which has no polarity in the resin but being prone to dye the monomer polymerized granular body having a polarity such as styrene derivatives, acrylic acid or methacrylic acid derivatives, or the like. These characteristics depend on compatibility of the resin and the dye, so that the disperse dye selectively colors only the monomer polymerized granular body which is highly compatible therewith.

Further, it is adoptable to use these dyes independently or in mixture of plural kinds in which it is particularly necessary to select a combination of dyes to get closer to black having a high molar extinction coefficient so as to increase the contrast to the white part of the seed granular body.

Furthermore, it is desirable that the amount of use of these dyes is about 0.1 wt % to about 10 wt % of the amount of the monomer. In the case of an amount of less than 0.1 wt %, the contrast to the white part is insufficient because the color concentration is low due to a too small amount of dye. On the other hand, when the amount exceeds 10 wt %, the dye which cannot dissolve in the resin precipitate as crystals to cause a problem that uniform coloring is difficult.

Subsequently, for the dyeing, the dyes are heated to the glass transition temperature or more of the polymerized granular bodies 3 to thereby transfer dye molecules to the polymerized granular bodies 3 for dyeing. It should be noted that the period required for the dyeing is about one hour to about two hours, and it is preferable to perform agitation to prevent the resin granular bodies 4 from settling during the dyeing.

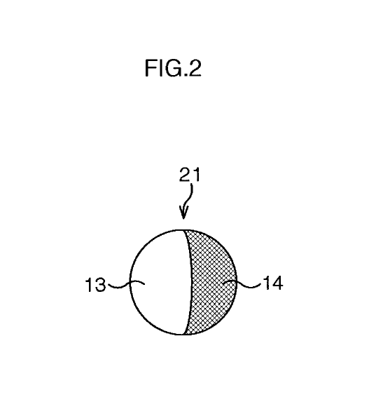

Subsequently, as shown in step S5, the snowman-shaped resin granular bodies 4 are integrally spheroidized (increases in sphericity) to complete colored rotating granular bodies 21 composed of white parts 13 having a high dielectric constant and colored parts 14 as shown in FIG. 2. This colored granular body 21 is configured such that the white part 13 has a high dielectric constant and the colored part 14 has a low dielectric constant.

The aforementioned polymerization stabilizer is added to the suspension of the resin granular bodies 4 here and agitated while the suspension is heated to a temperature higher than the glass transition temperature of the resin used for the seed granular bodies 1. In this case, the aforementioned surface active agent may also be added in order to increase the effect of preventing coalescence of the colored rotating granular bodies 21.

Incidentally, the granular bodies which have been complexed during the process to step S3 might be sufficiently spheroidized depending on the materials used for the seed granular body and the monomer mixture. In this case, the colored rotating granular bodies 21 have already been obtained, and thus step S5 can be omitted.

As described above, according to this embodiment, the colored rotating granular bodies 21 can be realized which have a good balance between colored parts (the white parts 13 and the colored parts 14), have a diameter (a diameter of 100 μm or lower here) too small to be obtained by a mechanical granular body production method and an excellent sphericity, and are easily mass-produced.

Second Embodiment

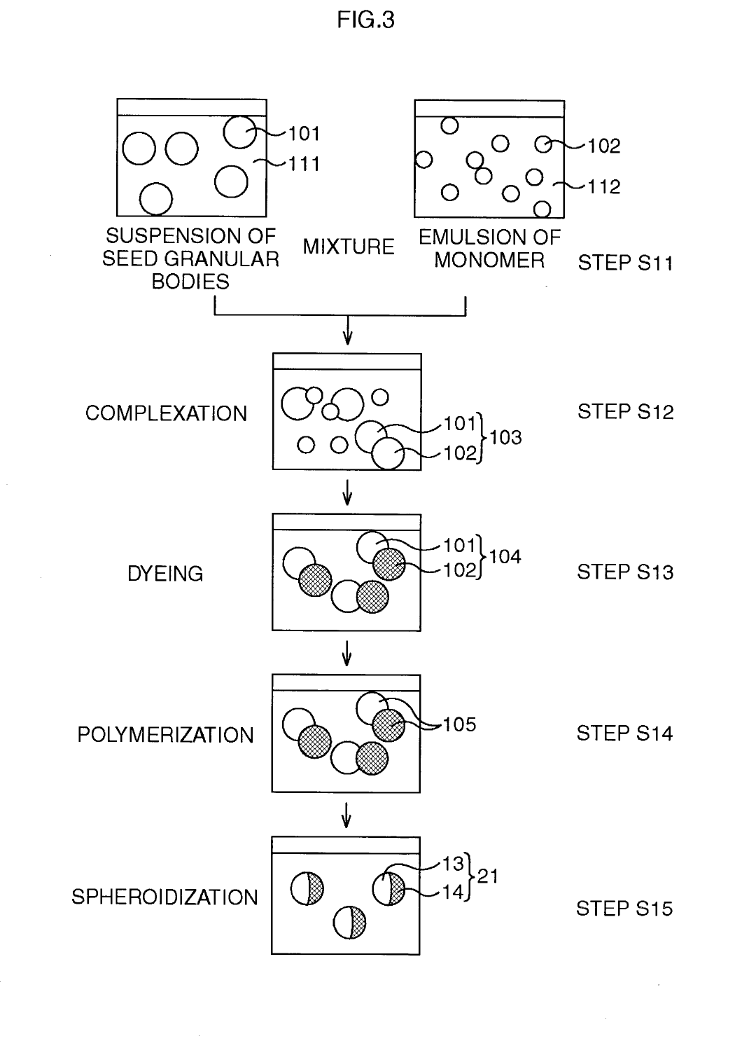

FIG. 3 is a diagram showing a method for producing colored rotating granular bodies in this embodiment in order of step. It should be noted that a configuration of the colored rotating granular body is explained together with the production method for convenience in this embodiment.

First of all, as shown in step S11, a suspension 111 of seed granular bodies 101 which are first granular bodies to become white parts and an emulsion 112 of a monomer 102 are prepared.

As the seed granular bodies which become the white parts of colored rotating granular bodies, either a substance obtained by dispersing a resin in a water-based medium or a substance obtained by polymerizing a monomer in a water-based medium is preferable. More preferably, it is suggested to use one or a mixture of two or more kinds selected from the group consisting of polyethylene, polypropylene, polyester, polyacryl, polyalkyd, polyimide, polycarbonate, carnauba wax, and paraffin wax. In particular, polypropylene and polyethylene each having a high degree of whiteness and high crystallinity in a solid state are preferable.

Further, in order to enhance the degree of whiteness and electrification performance of the seed granular bodies, one or a mixture of two or more kinds of white inorganic pigments such as titanium oxide, zinc oxide, silicon oxide, alumina, calcium carbonate, and so on, is dispersed in the seed granular bodies.

A grinding method, a spray-drying method, a suspension method, and the like can be cited as a method for producing seed granular bodies in which an inorganic pigment is dispersed.

The grinding method can produce granular bodies by mixing the aforesaid resin and white inorganic pigment, and melt-kneading them using a kneader, an extruder, or the like, thereafter roughly grinding the obtained mixture, then finely grinding it with a jet mill or the like, and finally using an air classifier.

The spray-drying method produces granular bodies by melting the similarly mixed resin and pigment and jutting it into an air to cool it.

The suspension method produces granular bodies by dispersing a white inorganic pigment, which has been subjected to hydrophobic processing with a silane coupling agent or the like, in a molten resin in an oil bath, dispersing it in a water-base medium in a water bath, and thereafter gradually decreasing its temperature.

The white granular bodies produced by the above-described method can be finely dispersed in water to obtain a suspension.

Next, the monomer emulsion 112 to be absorbed is explained.

Any monomer can be used here as long as it has one ethylene unsaturated bond in one molecule. For example, it is suggested to use styrene monomers such as styrene, o-methyl styrene, m-methyl styrene, p-methyl styrene, p-ethyl styrene, 2,4-dimethyl styrene, p-phenyl styrene, p-chloro styrene, 3,4-dichloro styrene, p-n-butyl styrene, p-tert-butyl styrene, p-n-hexyl styrene, p-n-octyl styrene, and p-n-dodecyl styrene; vinylester monomers such as vinyl acetate, vinyl propionate, and vinyl butyrate; acrylic ester monomers such as methyl acrylate, n-butyl acrylate, isobutyl acrylate, n-propyl acrylate, n-octyl acrylate, dodecyl acrylate, 2-ethylhexyl acrylate, stearyl acrylate, 2-chloro ethyl acrylate, and phenyl acrylate; methacrylic ester monomers such as methyl methacrylate, n-butyl methacrylate, isobutyl methacrylate, n-propyl methacrylate, n-octyl methacrylate, dodecyl methacrylate, 2-ethylhexyl methacrylate, stearyl methacrylate, 2-chloro ethyl methacrylate, and phenyl methacrylate; vinyl ether monomers such as vinyl methyl ether, vinyl ethyl ether, and vinyl isobuthyl ether; vinyl monomers such as acrylic acid or methacrylic acid derivatives, that is, acrylonitrile, methacrylonitrile, acrylamide, and so on. These monomers may be used singly or in a combination of two or more kinds.

Further, in order to control molecular weight distribution of the resin by combining with these monomers, divinylbenzene, divinyl naphthalene, divinyl ether, or the like may be added as a crosslinking agent.

To these monomers, a polymerization initiator is added in advance.

Cited as the polymerization initiator are peroxide such as benzoyl peroxide and lauroyl peroxide; persulfate such as potassium peroxodisulfuric acid, sodium persulfate, and ammonium persulfate; azo compound such as 2,2-azobis (2,4-dimethylvaleronitrile), 2,2-azobis (isobutyronitrile), and so on. Normally, the content of the polymerization initiator preferably ranges from 0.01 wt % to 10 wt % of the monomer mixture, and more preferably, 0.05 wt % to 7 wt % thereof. Moreover, a polymerization modifier such as tert-dodecanethiol or the like may be added as necessary in addition to the polymerization initiator.

Further, a surface active agent may be added to water in advance to prepare the monomer emulsion.

Cited as the surface active agent are an anionic surface active agent such as sodium dodecyl sulfate and sodium dodecyl benzenesulfonate; an nonionic surface active agent such as polyoxyethylene lauryl ether and polyoxyethylene nonyl phenyl; a cationic surface active agent such as lauryl trimethylammonium chloride, and so on.

Subsequently, as shown in step S12, the emulsion 112 of the monomer mixture is added to the suspension 111 of the seed granular bodies 101, so that the monomer mixture 102 attaches to the seed granular bodies 101 to complex with each other to obtain complexed granular bodies 103.

This complexation is carried out with a liquid mixture kept at room temperature not higher than a temperature of polymerization of the monomer or under cooling conditions. If the temperature in this event is close to the temperature of polymerization of the monomer, the monomer does not complex with the seed granular bodies but is prone to polymerize while keeping the state of monomer droplets. As a result, they do not form into complexed granular bodies but into substantially spherical resin granular bodies. In order to obtain complexed granular bodies, the complexation is desirably conducted at a temperature as low as possible but not so low as the water-based medium start freezing.

A period required for the complexation is normally from about several tens of minutes to about several hours. It is conceivable that when the suspension 111 of the seed granular bodies and the monomer emulsion 112 are mixed, a trace amount of molecules of the monomer mixture 102 dissolved in water precipitate on the surfaces of the seed granular bodies 101. In such a manner, the monomer mixture 102 transfers from the monomer emulsion 102 to the seed granular bodies 101.

It is conceivable here that when the monomer mixture 102 and the seed granular body 101 have a too high affinity for each other, the seed granular body 101 absorbs the monomer mixture 102 and swells to increase in granular body diameter. In this case, no complexed granular body will be obtained.

Meanwhile, it is conceivable that if a seed granular body which little dissolves in a monomer is used, a trace amount of the monomer mixture dissolved in water locally gathers when precipitating on the surface of the seed granular body to reduce its surface energy and thus unevenly attaches to the surface of the seed granular body. It is conceivable that the complexation of the seed granular body with the monomer mixture advances to provide an objective complexed granular body.

In this embodiment, the monomer mixture 102 is made into fine droplets and dispersed in the emulsion 112 before the monomer mixture 102 and the seed granular bodies 101 are mixed.

This increases the total surface area of the monomer mixture to accelerate elution of the monomer mixture into water. Further, it is desirable that the diameter of the droplet of the monomer mixture is made smaller than that of the seed granular body. If the diameter of the droplet of the monomer mixture is large, a part of the monomer mixture does not complex with the seed granular bodies but is prone to become by-product granular bodies. For emulsification of the monomer mixture, it is possible to use a typical emulsifier, for example, a rotor-stator emulsifier, a high-pressure emulsifier, an ultrasonic emulsifier, or the like.

Subsequently, as shown in step S13, only the monomer mixture 102 attached to the seed granular bodies 101 is selectively allowed to absorb a dye to obtain colored granular bodies 104. This is conducted before the completion of the polymerization of the monomer mixture 102, that is, before starting or during the polymerization. The coloring performed before the completion of the polymerization permits the dye to easily dissolve and osmose into the granular bodies 104, resulting in higher contrast.

The dye for coloring only the part of the monomer mixture 102 in a water-based medium desirably has a dissolving ability of a solubility of less than 1 wt % to a substance obtained by melting a component of the seed granular body 101 or a monomer constituting the seed granular body 101 and has a solubility of 2 wt % or more to the monomer mixture 102 which has attached to the seed granular body 101 afterward.

If a dye has a solubility of 1 wt % or more to the component constituting the seed granular body, the seed granular body is also colored. On the other hand, if the dye has a solubility of less than 2 wt % to the monomer which has attached to the seed granular body afterward, the granular body part which has attached afterward hardly have a sufficient color concentration. The contrast is insufficient in either case in serving the purpose as a display element.

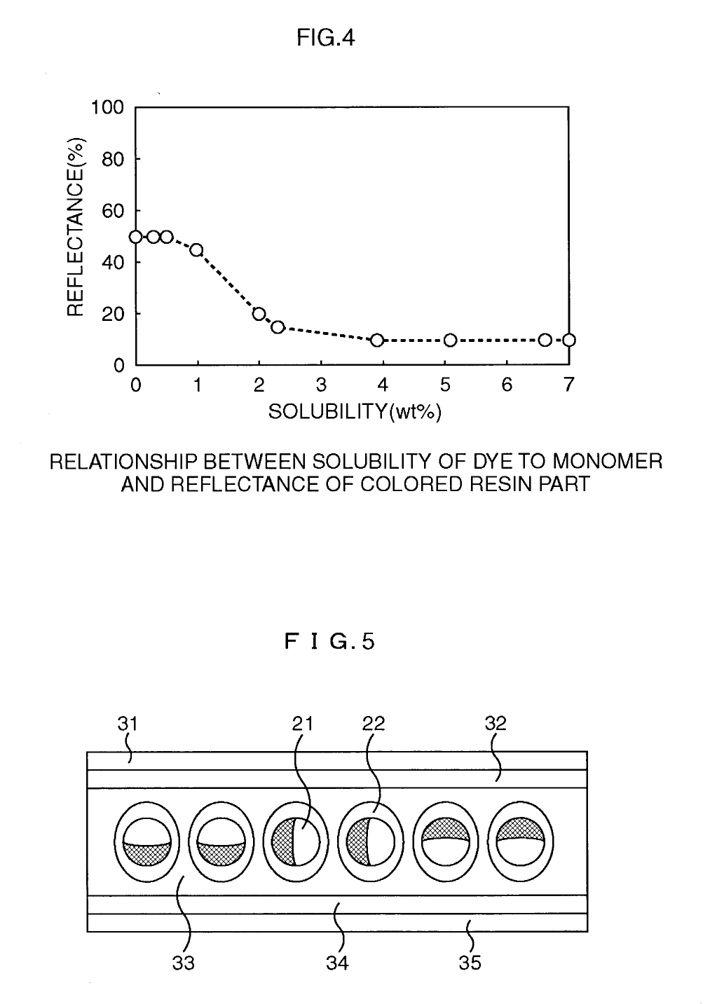

The relationship between the solubility of a dye to a monomer and the reflectance of a colored resin granular body is shown here in FIG. 4. This chart shows the result of tests on samples made as follows. Each of dyes having different solubilities is added in excess (about 10 wt % to a monomer mixture) to an emulsion of a monomer mixture (whose detail composition is the same as that of the first embodiment), polymerization is completed, and excessive dye crystals which do not contribute to the coloring of the resin are removed to obtain resin granular bodies. The resin granular bodies are compression-molded into the shape of a sheet having a film thickness of 100 μm for the test. The diagram in FIG. 4 shows that the reflectance is high (close to white) when a dye having a low solubility is used, and the reflectance is sufficiently low (close to black) when a dye having a solubility of 2 wt % or more is used.

Furthermore, it is desirable that the amount of use of these dyes is about 2 wt % to about 10 wt % of the monomer mixture. In the case of an amount of less than 2 wt %, the contrast to the white part is insufficient because the color concentration is low due to a too small amount of dye. On the other hand, when the amount exceeds 10 wt %, a large amount of dye which cannot dissolve in the monomer mixture precipitate as crystals to cause a problem in the following steps.

Cited as usable dyes, which are different according to the composition of the monomer mixture, are C. I. Solvent Blue 63, C. I. Disperse Violet 31, C. I. Disperse Red 22, C. I. Solvent Red 168, C. I. Solvent Yellow 93, C. I. Solvent Yellow 16, and the like. These dyes may be used singly or in a combination of two or more kinds.

Subsequently, as shown in step S14, the part of the monomer mixture 102 attached to the seed granular bodies 101 is polymerized by a method such as heating or the like to obtain colored and complexed resin granular bodies 105.

During the polymerization, it is desirable to perform slow agitation to prevent the granular bodies from settling.

It should be noted that a water-soluble polymerization inhibitor such as hydroquinone or the like may be added before the polymerization in order to prevent occurrence of by-product granular bodies in water.

Further, a suspension stabilizer may be added before the polymerization in order to enhance the stability of the resin granular bodies 105 obtained by complexing the seed granular bodies 101 and the granular bodies which have been polymerized afterward. As the suspension stabilizer, it is possible to use an anionic or a nonionic surface active agent; a water-insoluble powder such as tricalcium phosphate, barium sulfate, aluminum hydroxide, or silica; a hydrophilic polymer such as polyvinyl alcohol, polyvinyl pyrrolidone, gelatin, or methylcellulose, or the like.

Subsequently, as shown in step S15, if necessary, the polymerization-completed resin granular bodies 105 are integrally spheroidized (increases in sphericity) to complete colored rotating granular bodies 21 composed of white parts 13 having a high dielectric constant and colored parts 14 having a low dielectric constant as shown in FIG. 3.

The aforementioned suspension stabilizer is added here, if necessary, to the suspension of the polymerization-completed resin granular bodies 105, and agitated while the suspension is heated to a temperature close to the melting point of the resin used for the seed granular bodies 101.

Incidentally, the granular bodies which have been complexed during the process to step S14 might be sufficiently spheroidized depending on the materials used for the seed granular body and the monomer mixture. In this case, the colored rotating granular bodies 21 have already been obtained, and thus step S15 can be omitted.

As described above, according to this embodiment, the colored rotating granular bodies 21 can be realized which have a high contrast between colored parts (the white parts 13 and the colored parts 14), have a diameter (a diameter of 100 μm or lower here) too small to be obtained by a mechanical granular body production method and an excellent sphericity, and are easily mass-produced.

Third Embodiment

Next, a configuration of a display device according to this embodiment is explained.

This display device is a display device having a function capable of easily rewriting electronic information in addition to flexibility equal to paper, that is, so-called digital paper.

The display device of this embodiment has, as shown in FIG. 5, a pair of films 31 made of transparent members having transparent electrodes 32 on the surface, respectively. Further, the display device is constituted by a disperse system 33 made by dispersing colored rotating granular bodies 21 of the embodiment in a predetermined dielectric liquid sandwiched between the pair of films 31 with the transparent electrodes 32 opposed. The disperse system 33 is formed by sealing the colored rotating granular bodies 21 in a transparent material such as silicon rubber or the like, and swelling the material by a medium such as a silicon oil or the like to form cavities necessary for rotation around the colored rotating granular bodies 21.

In this display device, the colored rotating granular body 21 rotates a half turn by applying a predetermined potential to the transparent electrodes 32 due to the difference in dielectric constant between a white part 13 and a colored part 14 which constitute the colored rotating granular body 21 in the disperse system 33 to display an associated colored face. This realizes an image display.

According to the display device of this embodiment, the colored rotating granular body 21 having an extremely small granular body diameter and an excellent sphericity is provided as a display element, thereby enabling an image display which is extremely fine and has a high image resolution and a high contrast (a difference in reflectance between the white part and the colored part of at least 50% or more).

### EXAMPLES

Hereinafter, a method for producing the colored rotating granular bodies of the present invention will be explained more specifically as examples.

### Example 1

Polyethylene WAX (by Mitsui Chemicals, Inc.) was melted by heating, and thereafter titanium oxide (by Titan Kogyo Kabushiki Kaisha) was dispersed therein at a rate of 5 wt % and cooled. This was ground by IKA Universal Mill (by IKA-Werke GmbH & Co. KG), and thereafter classified by a mesh to obtain white resin granular bodies having an average granular body diameter of 10 μm. 50 parts by weight of the white resin granular bodies were agitated in a dispersion including 0.3 parts by weight of sodium dodecyl sulfate in 500 ml water to prepare the suspension.

Next, a monomer phase obtained by mixing 75 parts by weight of styrene and 4 parts by weight of azo series polymerization initiator (V-65) as a polymerization initiator was added to a solution obtained by dissolving 0.1 parts by weight of sodium dodecyl sulfate in 750 ml water.

A monomer emulsion is prepared from this solution through the use of a high pressure homogenizer (by Micro Fluidize).

The suspension of the white resin granular bodies was added to the monomer emulsion and agitated at room temperature for two hours to thereby complex seed granular bodies and monomer granular bodies. After 0.5 parts by weight of sodium dodecyl sulfate was added to the suspension of the complexed granular bodies, polymerization was performed at 70° C. for eight hours.

2.5 parts by weight of C. I. Disperse Blue 183 (by Mitsui Toatsu Senryo) was added as a disperse dye to the polymerized granular bodies and agitated at 80° C. for one hour to dye the polymerized granular bodies. After the dyeing, snowman-shaped resin granular bodies were obtained, each of which was separated into halves of a white part and a colored part. One part by weight of polyvinyl alcohol was added as a suspension stabilizer to the above and agitated at 90° C. for two hours to thereby conduct a heat treatment. A small amount of secondary produced resin minute powder and dye crystals were removed by decantation, and after washing and drying, colored rotating granular bodies were obtained. The average granular body diameter of the colored rotating granular bodies was 20 μm.

### Example 2

In place of Polyethylene WAX used in the example 1, polypropylene WAX (by Mitsui Chemicals, Inc.) was used to produce a suspension. Materials and steps other than that are the same as those of the example 1. Spherical colored rotating granular bodies each of which was separated into halves of a white part and a colored part were obtained as in the example 1. The average granular body diameter of the colored rotating granular bodies was 20 μm.

### Example 3

In place of styrene monomer used in the example 1, methyl methacrylate was used to produce a monomer emulsion. Materials and steps other than that are the same as those of the example 1. Spherical colored rotating granular bodies each of which was separated into halves of a white part and a colored part were obtained as in the example 1. The average granular body diameter of the colored rotating granular bodies was 20 μm.

### Example 4

In place of C. I. Disperse Blue 183 used in the example 1, C. I. Disperse Red 60 (by Mitsui Toatsu Senryo) was used for dyeing. Materials and steps other than that are the same as those of the example 1. The average granular body diameter of the colored rotating granular bodies was 20 μm.

### Example 5

Polyethylene WAX (by Mitsui Chemicals, Inc.) was melted by heating, and thereafter titanium oxide (by Titan Kogyo Kabushiki Kaisha) was dispersed therein at rate of 10 wt %. 50 parts by weight of the molten mixture was charged into 450 parts by weight of 1 wt % polyvinyl alcohol solution heated to 95° C. and agitated by Biscotron (by SMT Co., Ltd.) and cooled to prepare a suspension of seed granular bodies.

The result of measurement of the reflectance of the white seed granular bodies when compression molded into the shape of a film of 100 μm was 65%.

Next, a monomer mixture obtained by mixing 85 parts by weight of styrene, 15 parts by weight of butyl acrylate, and 4 parts by weight of azo series polymerization initiator (V-65) is charged into 900 parts by weight of 0.05 wt % sodium dodecyl sulfate solution and agitated by CLEARMIX (by Clear) to prepare an emulsion of the monomer mixture.

The emulsion of the monomer mixture was added to the suspension of the seed granular bodies and agitated at room temperature for two hours to complex the seed granular bodies and the monomer mixture.

While this suspension is increased in temperature to 70° C., 15 parts by weight of sodium dodecyl sulfate was added thereto, and 7.0 parts by weight of C. I. Solvent Blue 63 (by Arimoto Chemical Co., Ltd., whose solubility to a melt of the aforementioned wax was almost 0 wt % and whose solubility to the monomer mixture was 6.6 wt %) was added thereto as a dye to color the part of the monomer mixture.

Subsequently, the suspension was kept at 70° C. for six hours and further agitated at 95° C. for two hours for polymerization and spheroidization processing.

A small amount of secondary produced resin minute powder and remaining dye crystals were removed by filtration, and after washing, spherical complexed resin granular bodies were obtained.

Aside from the above, sodium dodecyl sulfate and the dye C. I. Solvent Blue 63 were similarly added only to the emulsion of the monomer mixture, and after similar polymerization, filtration and washing, colored granular bodies were obtained. The reflectance of the colored granular bodies filled in the shape of a sheet of 100 μm was measured. The result was 10%.

The above-described complexed resin granular body had an average granular body diameter of 20 μm and a sufficient contrast as a colored rotating granular body color-coded such that a hemisphere was white (a reflectance of 65%) and another hemisphere was dark blue (a reflectance of 10%).

### Example 6

Spherical complexed resin granular bodies were obtained in the same manner as that of the example 5 except that, in place of C. I. Solvent Blue 63 used in the example 5, SMS-5 (by Nippon Kayaku Co., Ltd., whose solubility to a melt of the aforementioned wax was almost 0 wt % and whose solubility to the monomer mixture was 2.3 wt %).

Aside from the above, colored granular bodies without using seed granular bodies were produced in the same manner as that of the example 5 except for the use of SMS-5 as a dye, and the reflectance of the colored granular bodies was measured. The result was 15%.

The above-described complexed resin granular body had an average granular body diameter of 20 μm and a sufficient contrast as a colored rotating granular body color-coded such that a hemisphere was white (a reflectance of 65%) and another hemisphere was dark red (a reflectance of 15%).

### Example 7

Spherical complexed resin granular bodies were obtained in the same manner as that of the example 5 except for the addition of 6.0 parts by weight of C. I. Solvent Blue 63 and 2.0 parts by weight of SMS-5.

Aside from the above, colored granular bodies without using seed granular bodies were produced in the same manner as that of the example 5 except for the use of 6.0 parts by weight of C. I. Solvent Blue 63 and 2.0 parts by weight of SMS-5, and the reflectance of the colored granular bodies was measured. The result was 5%.

The above-described complexed resin granular body had an average granular body diameter of 20 μm and a sufficient contrast as a colored rotating granular body color-coded such that a hemisphere was white (a reflectance of 65%) and another hemisphere was purple close to black (a reflectance of 5%).

### Comparative Example 1

Complexed resin granular bodies were obtained in the same manner as that of the example 5 except that, in place of C. I. Solvent Blue 63 used in the example 5, C. I. Disperse Blue 14 (by Nippon Kayaku Co., Ltd., whose solubility to a melt of the aforementioned wax was almost 0 wt % and whose solubility to the monomer mixture was 0.5 wt %).

Aside from the above, colored granular bodies without using seed granular bodies were produced in the same manner as that of the example 5 except for the use of C. I. Disperse Blue 14, and the reflectance of the colored granular bodies was measured. The result was 50%.

The above-described complexed resin granular body had an average granular body diameter of 20 μm, a hemisphere being white (a reflectance of 65%) and another hemisphere being pale blue (a reflectance of 50%). As a result, the granular body did not have a sufficient contrast as a colored rotating granular body.

### Comparative Example 2

Complexed resin granular bodies were obtained in the same manner as that of the example 5 except that, in place of C. I. Solvent Blue 63 used in the example 5, C. I. Solvent Red 207 (by Arimoto Chemical Co., Ltd., whose solubility to a melt of the aforementioned wax was almost 0 wt % and whose solubility to the monomer mixture was 0.3 wt %).

Aside from the above, colored granular bodies without using seed granular bodies were produced in the same manner as that of the example 5 except for the use of C. I. Solvent Red 207, and the reflectance of the colored granular bodies was measured. The result was 50%.

The above-described complexed resin granular body had an average granular body diameter of 20 μm, a hemisphere being white (a reflectance of 65%) and another hemisphere being pale red (a reflectance of 50%). As a result, the granular body did not have a sufficient contrast as a colored rotating granular body.

### Comparative Example 3

Complexed resin granular bodies were obtained in the same manner as that of the example 5 except that, the addition of a dye immediately after the complexation of the granular bodies was omitted and a dye was added just after completion of agitation at 70° C. for six hours.

Aside from the above, colored granular bodies without using seed granular bodies were produced in the same manner as that of the example 5 except for the addition of a dye just after completion of agitation at 70° C. for six hours, and the reflectance of the colored granular bodies was measured. The result was 35%.

The above-described complexed resin granular body had an average granular body diameter of 20 μm, a hemisphere being white (a reflectance of 65%) and another hemisphere being pale blue (a reflectance of 35%). As a result, the granular body did not have a sufficient contrast as a colored rotating granular body.

According to the present invention, it is possible to provide a method for producing colored rotating granular bodies each having a high contrast between colors, a diameter too small to be obtained by a mechanical granular body production method and an excellent sphericity, and being easily mass-produced in a short time.

Further, the present invention enables color-coding in two colors with high color concentrations and spheroidization of a colored rotating granular body that are difficult by the polymerization method, thereby providing a colored rotating granular body having a good contrast and capable of smoothly rotating.

Furthermore, according to the present invention, the colored rotating granular body can easily be decreased in diameter down to about several tens of microns to about several microns, so that it is possible to realize a display device having a high resolution for extremely fine image and a high contrast.

The present embodiments are to be considered in all respects as illustrative and no restrictive, and all changes which come within the meaning and range of equivalency of the claims are therefore intended to be embraced therein. The invention may be embodied in other specific forms without departing from the spirit or essential characteristics thereof.

What is claimed is:

1. A method for producing colored rotating granular bodies each having a surface color-coded in two different colors and different electrification characteristics for each color and rotating by an effect of an electric field to display an associated color face, comprising the steps of:
a first step of mixing a suspension of first granular bodies each already in a colored state and functioning as a base and a monomer mixture which becomes second granular bodies, and unevenly attaching said monomer mixture to a part of a surface of said each first granular body for complexation;
a second step of polymerizing said monomer mixture attached to said first granular bodies to obtain said second granular bodies; and
a third step of selectively coloring only said second granular bodies.

2. The method for producing colored rotating granular bodies according to claim 1, further comprising:
a fourth step of integrally spheroidizing said complexed first granular bodies and second granular bodies.

3. The method for producing colored rotating granular bodies according to claim 1, wherein
said first granular body is colored at least with a white pigment.

4. The method for producing colored rotating granular bodies according to claim 3, wherein
said first granular body is composed of one or a mixture of two or more kinds selected from the group consisting of polyethylene, polypropylene, polyester, polyacryl, polyalkyd, polyimide, polycarbonate, carnauba wax, amide wax, and paraffin wax, and is colored with said white pigment.

5. The method for producing colored rotating granular bodies according to claim 3, wherein
said white pigment is one or a mixture of two or more kinds selected from the group consisting of titanium oxide, zinc oxide, silicon oxide, alumina, and calcium carbonate.

6. The method for producing colored rotating granular bodies according to claim 1, wherein
said monomer is one or a mixture of two or more kinds selected from the group consisting of styrene derivatives, acrylic esters, acrylic acid derivatives, methacrylic esters, methacrylic acid derivatives, olefin derivatives, vinyl ether derivatives, and vinylester derivatives.

7. The method for producing colored rotating granular bodies according to claim 1, wherein
said first step comprises the steps of:
obtaining an emulsion of said monomer; and
mixing said suspension of said first granular bodies and said emulsion of said monomer.

8. The method for producing colored rotating granular bodies according to claim 1, wherein
said third step is a step of performing said coloring of said second granular bodies by dyeing using a dye.

9. The method for producing colored rotating granular bodies according to claim 1, wherein
said fourth step is a step of performing said spheroidization by heating at a temperature higher than a glass transition temperature of said first granular body.

10. A method for producing colored rotating granular bodies each having a surface color-coded in two different colors and different electrification characteristics for each color and rotating by an effect of an electric field to display an associated color face, comprising the steps of:
a first step of mixing a suspension of first granular bodies each already in a colored state and functioning as a base and a monomer mixture which becomes second granular bodies, and unevenly attaching said monomer mixture to a part of a surface of said each first granular body for complexation;
a second step of selectively coloring only a part of said monomer mixture which becomes said second granular bodies; and
a third step of polymerizing said monomer mixture attached to said first granular bodies to obtain said second granular bodies.

11. The method for producing colored rotating granular bodies according to claim 10, further comprising:
a fourth step of integrally spheroidizing said complexed first granular bodies and second granular bodies.

12. The method for producing colored rotating granular bodies according to claim 10, wherein
said first granular body is colored at least with a white pigment.

13. The method for producing colored rotating granular bodies according to claim 10, wherein
said first step comprises the steps of:
obtaining an emulsion of said monomer mixture; and
mixing said suspension of said first granular bodies and said emulsion of said monomer mixture.

14. The method for producing colored rotating granular bodies according to claim 10, wherein
said second step is a step of performing said coloring of said monomer mixture by dyeing using a dye.

15. The method for producing colored rotating granular bodies according to claim 14, wherein
said dye has a solubility of less than 1 wt % to a substance obtained by melting a component of said first granular body or a monomer constituting said first granular body, and has a solubility of 2 wt % or more to a monomer constituting said second granular body.

16. The method for producing colored rotating granular bodies according to claim 11, wherein
said fourth step is a step of performing said spheroidization by heating at a temperature higher than a glass transition temperature of said first granular body.

17. A colored rotating granular body having a surface color-coded in two different colors and different electrification characteristics for each color and rotating by an effect of an electric field to display an associated color face, said granular body comprising:
a first granular body made of a resin; and
a second granular body obtained by coloring a monomer mixture by dyeing in a color different from that of said first granular body and polymerizing it while attached to said first granular body,
said first granular body and said second granular body being complexed and integrally spheroidized.

18. A display device, comprising:
a pair of opposing electrode substrates at least one of which is transparent; and
a disperse system sealed between said opposing electrode substrates and including colored rotating granular bodies,
wherein said colored rotating granular body is a display element having a surface color-coded in two different colors and different electrification characteristics for each color and rotating by an effect of an electric field to display an associated color face, and
said granular body is constituted by a first granular body made of a resin and a second granular body obtained by coloring a monomer mixture by dyeing in a color different from that of said first granular body and polymerizing it while attached to said first granular body, said first granular body and said second granular body being complexed and integrally spheroidized.

19. The display device according to claim 18, wherein
said first granular body is colored at least with a white pigment.

20. The display device according to claim 19, wherein
said first granular body is composed of one or a mixture of two or more kinds selected from the group consisting of polyethylene, polypropylene, polyester, polyacryl, polyalkyd, polyimide, polycarbonate, carnauba wax, amide wax, and paraffin wax, and is colored with said white pigment.

21. The display device according to claim 19, wherein
said white pigment is one or a mixture of two or more kinds selected from the group consisting of titanium oxide, zinc oxide, silicon oxide, alumina, and calcium carbonate.

22. The display device according to claim 18, wherein
said monomer is one or a mixture of two or more kinds selected from the group consisting of styrene derivatives, acrylic esters, acrylic acid derivatives, methacrylic esters, methacrylic acid derivatives, olefin derivatives, vinyl ether derivatives, and vinylester derivatives.
